(19) United States
(12) Patent Application Publication
(10) Pub. No.: US 2006/0272002 A1
(43) Pub. Date: Nov. 30, 2006

(54) Method for automating the management and exchange of digital content with trust based categorization, transaction approval and content valuation

(75) Inventors: Doug Wightman, Kingston (CA); Edward Cassola, Oakville (CA); John Cardella, Aurora (CA)

Correspondence Address: Edward Cassola, 2194 Rosemount Crescent, Oakville, L6M3P4, CA

(73) Assignee: GENERAL KNOWLEDGE TECHNOLOGY DESIGN, Aurora (CA)

(21) Appl. No.: 10/908,776

(22) Filed: May 25, 2005

(51) Int. Cl. H04L 9/00

(52) U.S. Cl. 726/1

(57) ABSTRACT

A method for automating the decisions involved in digital content management. It accomplishes these goals through the definition of machine-actionable rules for categorization, transfer approval and content valuation. These rules in turn approve or deny requests for action based on the degree of trust (calculated as reputation) of the counterparty or content in question.

### BACKGROUND OF THE INVENTION

Present means of exchanging digitally encoded information (“content”) leave much efficiency to be desired. It is possible to automate the following processes:

becoming aware of useful and available content,

suggesting useful information to others,

requesting such information from others,

transmitting information, and

evaluating such transmissions both in terms of the worth of the information and the quality of the transaction.

The automation of these processes should be user customizable in a manner that is aligned with their individual criteria. The appropriate content should be shared with the appropriate counterparties, based on each individual's preferences, which means all three must be easily identifiable and categorized. The decisions involved in this process are in real life based on trust and reputation of those that an individual interacts with. Things should be no different in a digital environment. However, the automation of these decisions is not simple task.

In addition to the improvements mentioned above, those individuals who provide greater value (as assessed by others) should be rewarded. This value can take the form of (but is not limited to) sharing resources such as better/newer content or more network bandwidth. In one instance, the reward can take the form of more access to and control over desired content. This is a similar model to the simplex model employed by the “BitTorrent” file sharing application, which rewards upload contribution with increased download bandwidth. The model is an attempt to align with the interests of a system that wishes to reward social contribution in an equitable manner. A more ideal, complex system would allow social contribution to take the form of currency—a unit upon which to make exchanges. It would also place a focus on reliability through reputation—the extent to which an individual can be trusted to behave in a certain manner.

As they exist today, mechanisms for tracking reputation and using it as a basis for future action are fairly limited in scope and flexibility. One such example is the “BitTorrent” model alluded to above. This does not allow for reputations to be maintained from previous downloads, or to assess the quality of the content transferred in these downloads. The structure employed by online sales/auction sites such as eBay also falls short of efficiently and powerfully using past behaviour to predict the success of future transactions. The ‘eBay’ model allows for user feedback of each transaction as either a “positive”, “negative” or “neutral” experience. Each past counterparty's opinion is given equal weight, regardless of the relevance of the transaction they are referring to, and the likelihood that their opinions are honest and accurate.

The process of building, asserting, and assessing this reputation can be automated. This is an ambitious goal which has not yet been undertaken. For reputation to be represented dynamically, it must take into account such factors as:

individual preferences and criteria for trust;

past behaviour in previous transactions;

the type of content exchanged in previous transactions, weighted in terms of relevance to a future transaction;

for those whose opinion is included in a user's reputation, a weighting of the likelihood that their assertions are true (that is, a weighting of their opinions based on their respective reputations);

ANY other factor that is considered to be relevant to a decision.

Allowing for this functionality is the only way to efficiently reach the goal of automating the processes described at the beginning of this document for all forms of exchange of digital information, and on a scale as large as that of the non-digital world.

Once the functionality is achieved, compensation for social contribution (as described above) can be valuated through the grading of content and individuals as successful (compliant) parties to rules or groups of rules (agreements). These parties can belong to multiple groups at the same time, with different rules applying to each, and with automated actions taking place based on the calculated (relevant) reputation for each particular individual and transaction.

### SUMMARY OF THE INVENTION

This invention is the preferred embodiment of the functionality described in the preceeding background. That is, it is a method for automating the decisions involved in digital content management. It accomplishes these goals through the definition of machine-actionable rules for categorization, transfer approval and content valuation. These rules in turn approve or deny requests for action based on the degree of trust (calculated as reputation) of the counterparty or content in question.

### BRIEF DESCRIPTION OF THE DRAWINGS

FIG. 1 is a high-level system diagram illustrating the general case process of automating content exchange.

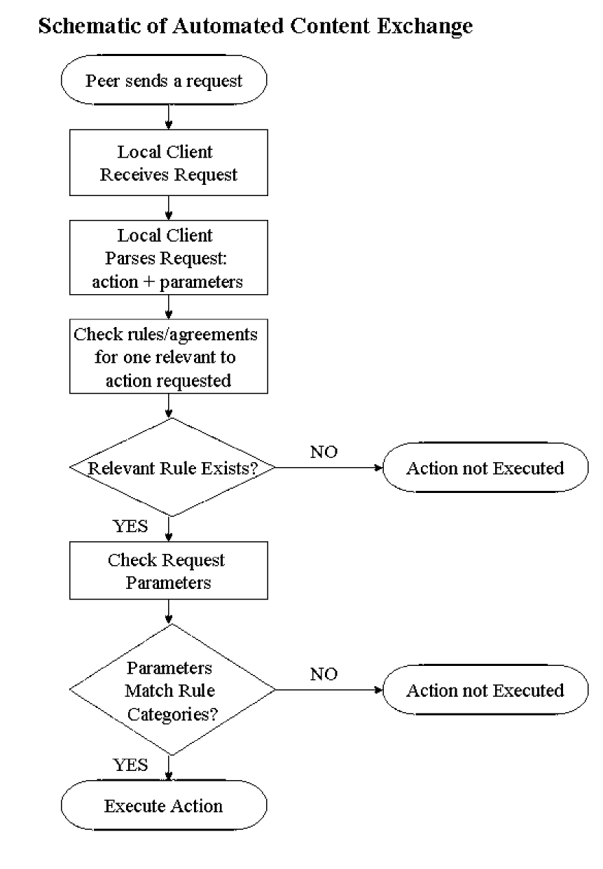

### BEST MODE FOR CARRYING OUT THE INVENTION

Requests. Each individual runs a client that is always ‘listening’ for requests. These requests are compared to what the individual has indicated they are willing to do, that is, which types of transactions they are willing to participate in, and with whom. Some of these requests are accepted. When they are accepted, the request is executed (e.g. if the request was a query for files, the list of files that the individual is willing to share are returned). If desired, digital receipts indicating that this request was made and that the request was fulfilled are also exchanged (see below).

Automated Transaction Approval and Compensation.

Past Behaviour: Digital receipts. Past behaviour is logged (according to each user's preferences) by an exchange of digital receipts for a transaction (for example, the request for information and the fulfillment of that request). These digital receipts contain a record of the success of the transaction from the point of view of each counterparty involved (claim 5). They are eventually shared, as promises to behave in a certain way in the future, that is, to be considered as reputation.

Reputation. The digital receipts described above are shared, as a self-assertion of reputation and selectively considered (according to relevance) in assessing the likelihood that a potential counterparty to a transaction will behave as they are expected to (claim 6, 7).

The consideration of receipts is also based on the likelihood that the opinions of those 3^{rd} parties who issued them are honest and accurate (their reputations). If ‘A’ wants to procure a file from ‘B’, ‘B’ offers a reputation claim made up of opinions from ‘X’, ‘Y’, and ‘Z’ that were recorded upon the completion of past transactions ‘1’, ‘2’, ‘3’. ‘A’ considers this information and weights it based on the relevance of the past transactions (claim 9), and the reputations of ‘X’, ‘Y’, and ‘Z’. The method for selectively considering these digital receipts is defined through rules, or agreements (groups of rules) by which users agree to abide, thus forming communities of users with common interests and goals.

Agreements. Agreements contain the code to both create and respond to requests. They also have an interface to allow all the rules associated with each request to be set (by the user, or automatically). Agreements are therefore (from the user's perspective) an organized set of requests and rules which can be given to others, in order to give people the opportunity to engage in the same sort of sharing (claim 13).

Categorization. The agreements described above each deal with specific types of transactions and specific types of content. Ascertaining the relevance of content to an agreement requires it to be categorized in some fashion. The same applies for reputation claims in the form of digital receipts. Categorization:

determines against which agreement(s) to assess a request and the reputation it claims, by allowing comparison of a request's parameters with those expected by the rules available;

enables transaction approval by verifying whether or not all the digital receipts necessary to satisfy an agreement's categories have been supplied as parameters to a request;

allows reputation to be calculated as a function of the extent that categories are satisfied by request parameters (types and quantities of digital receipts).

assigns a value to the content being exchanged if so desired, and according to the reputation associated with the request.

In one embodiment, content categories are defined by rules for assessing what should be included in a list. They are organized as arrays, and generated in real-time based on code and/or database commands. They are “views” of the data on a user's computer. These views are completely interchangeable in agreements. For example, a category that defines “friends” could be swapped for a category that defines “everyone” thus changing the scope of an agreement (in this case, changing the type of people content is shared with). This example also illustrates that content can easily be part of more than one category, and that one category can be a subset of another.

Since these categories are generated in real-time, they can be dynamic. For example, upon becoming aware of a new user, the new user would automatically be in the “everyone” category (if such a category existed, along with every other existing category whose definition includes the new user) next time it is accessed. Categories can also define types of receipts which will be accepted when evaluating a request for certain files. This could change based upon dynamic variables, such as the number of receipts of each type which one currently has.

Content categories can be shared and exchanged much in the same way agreements can.

Valuation. Through reputation, agreements, and categorization, willingness to deal with a potential counterparty is evaluated as follows: the parameters associated and supplied with a request (as described by digital receipts) must belong to the categories defined by at least one of the rules the request for action is intended to invoke. Once a counterparty is deemed to have an acceptable reputation, the transaction in question is approved (claim 2). The value of content to each individual user is then computed based on this categorization (i.e. its relevance and likelihood to help reach the end goal of a transaction), and based on the already-computed reputation of the counterparty. If necessary, monetary compensation for the content can be integrated into the transaction.

Automation. The degree of automation of this process is completely user defined. It can be specified manually or (ideally) through agreements that are shared and traded as described above. Transfers can be based on implicit consent defined through the rules described above. This infrastructure will automate the exchange of content in return for the currency of reputation (and the extent to which it represents social contribution). Just as people that have money are trusted, people who have a reputation for behaving in a certain appropriate manner during relevant situations will also be trusted.

Interface and Further Implementation: The user's interface will allow the sending of requests for information. It will also allow for the setting of rules to govern the execution of requests from other users. These requests can be grouped into “agreements”: sets of requests which fulfill a common purpose.

Possible methods for defining rules include, but are not limited to:

A ‘wizard’ or ‘expression builder’ such as the mail agents used in email programs to create rules for the processing of incoming mail; and/or

manual definition of rule criteria through coding (programming) and saving rules or agreements.

Agreements can even allow for other users to define certain rules under certain circumstances.

### ADVANTAGES OVER PRIOR ART

The environment described in this document is particularly useful for the sharing and sale of digital works such as media files, documents, online articles/news, etc. In fact, a narrow embodiment of this invention would deal specifically with these formats of digital content, while a broader application of the technology would allow for similar management of more abstract information (activities, goals, tasks, best practices, etc). [Para 46] Users will share digital receipts to prove their reputation, and will request them of individuals they have not yet dealt with as proof that a 3^{rd} party (whose opinion can be weighted or disregarded based on their reputation) has had a successful experience in a similar transaction.

The environment will allow content creators to choose who to share their creations with, and how to price them. For example, it will be possible to know if an individual is likely to share purchased content with others, and whether or not these third parties are likely to pay the original vendor for their copy of the work. Through such evaluations, it will be possible to determine a price that will result in equitable compensation for the content creator. If a file is likely to reach many users that will not pay for it, the initial price will be high.

Regardless of the specific application of this technology, the result of this environment is that content of the highest relevance and quality will be automatically:

sourced (or suggested),

requested (or granted), and, if necessary, paid for (or sold).

This is a considerable and necessary leap in the way that digital content is managed and exchanged at the time of this publication.

What is claimed is:

1. A method for distribution of digital content through automated transaction approval, where said approval is obtained through a calculation of counterparty reputation based on user-defined criteria.

2. The method of claim 1, further comprising the step of considering a counterparty's past behavior as criteria for reputation.

3. The method of claim 1, further comprising the step of considering and using said reputation to automate content valuation.

4. The method of claim 3, further comprising the step of automating compensation decisions based on mutually agreeable levels of said content valuation.

5. The method of claim 2, further comprising the step of optionally logging digital receipts of past transactions as examples of said past behavior.

6. The method of claim 5, further comprising the step of using said digital receipts as an evaluation of the success of the transaction from the point of view of each respective counterparty.

7. The method of claim 5, further comprising the step of sharing digital receipts as a self-assertion of reputation.

8. The method of claim 1, further comprising the step of applying different criteria for reputation in different situations; that is, the dynamic calculation of reputation for every user, and for every transaction through selective consideration of digital receipts according to pre-defined rules and conditions.

9. The method of claim 8, further comprising the step of user-definition of said criteria.

10. The method of claim 9, further comprising the step of representing said criteria in the form of agreements by which users can abide and against which user reputation can be assessed.

11. The method of claim 10, further comprising the step of applying said criteria, depending on a transaction's relevance to one or more agreements.

12. The method of claim 11, further comprising the step of categorizing digital content with the purpose of discerning its membership to said agreements.

13. The method claim 3, further comprising the step of manual or automatic bartering with a counterparty to determine a final valuation based on preliminary valuations of both the buyer and seller.

14. The method of claim 10, further comprising the step of valuating said agreements as a form of digital content.

15. The method of claim 10, further comprising the step of sharing agreements as a form of digital content.
